(19) United States
(12) Patent Application Publication
(10) Pub. No.: US 2026/0160112 A1
(43) Pub. Date: Jun. 11, 2026

(54) PULLEY DEVICE

(71) Applicant: MITSUBA Corporation, Gunma (JP)

(72) Inventor: YOHEI INAGAKI, Gunma (JP)

(73) Assignee: MITSUBA Corporation, Gunma (JP)

(21) Appl. No.: 19/390,660

(22) Filed: Nov. 16, 2025

(30) Foreign Application Priority Data
Dec. 11, 2024 (JP) 2024-217010

(51) Int. Cl. E05F 15/643

(52) U.S. Cl. CPC E05F 15/643; E05Y 2201/668; E05Y 2900/531

(57) ABSTRACT

A front side pulley device 30 that converts a moving direction of a closed side cable 22 driven by a drive source. The front side pulley device includes: a pulley case 31, fixed to a body panel 11a; first and second pulley accommodating parts, provided inside the pulley case 31; first and second pulley shafts PS1 and PS2, provided in the first and second pulley accommodating parts, respectively; first and second pulleys rotatably supported by the first pulley shaft PS1 and the second pulley shaft PS2, respectively, around which the closed side cable 22 is wound; and first and second cable entry and exit holes HL1 and HL2 provided in the pulley case 31 and communicating between inside and outside of the pulley case 31.

### CROSS REFERENCE TO RELATED APPLICATIONS

This application claims the priority benefit of Japanese Patent Application No. 2024-217010, filed on December 11 2024. The entirety of the above-mentioned patent application is hereby incorporated by reference herein and made a part of this specification.

### BACKGROUND

### Technical Field

The disclosure relates to a pulley device that changes a moving direction of a cable.

### Description of Related Art

A slide door that moves in a front-rear direction of a vehicle to open and close an opening part is provided on a side part of a one-box vehicle or the like. The slide door is moved along a guide rail by a vehicle opening and closing device. Such a vehicle opening and closing device is described in, for example, Patent Document 1.

The vehicle opening and closing device described in Patent Document 1 is a cable type vehicle opening and closing device, and opens and closes the slide door by driving a cable with a drive device. In addition, the vehicle opening and closing device described in Patent Document 1 includes a pulley unit that changes a moving direction of the cable in order to guide the cable along a guide rail.

### [PRIOR ART DOCUMENTS]

### [Patent Documents]

### [Patent Document 1] Japanese Patent Application Publication No. 2020-084605

In the pulley unit described in Patent Document 1, a pulley and a guide plate are used to change the moving direction of the cable, and the cable is moved while rubbing against the guide plate. Therefore, there is a possibility that the resin coating covering the surface of the cable may wear out prematurely, and the maintenance cycle becomes shorter.

The disclosure is to provide a pulley device capable of extending a maintenance cycle.

### SUMMARY

According to an aspect of the disclosure, a pulley device converting a moving direction of a cable driven by a drive source includes: a pulley case, fixed to a mounting object; multiple pulley accommodating parts, provided inside the pulley case; a pulley shaft, provided in each of the pulley accommodating parts; multiple pulleys, which are respectively rotatably supported by the pulley shafts and around which the cable is wound; and a pair of cable entry and exit holes, provided in the pulley case and communicating between inside and outside of the pulley case.

### BRIEF DESCRIPTION OF THE DRAWINGS

FIG. 1 is a schematic view of a vehicle equipped with a power slide door device.

FIG. 2 is a perspective view showing the power slide door device of FIG. 1.

FIG. 3 is a perspective view for describing a mounting structure of a front side pulley device to a body panel.

FIG. 4 is a perspective view of the front side pulley device as viewed from the left side and the rear side.

FIG. 5 is a perspective view of the front side pulley device as viewed from the right side and the rear side.

FIG. 6 is a view of the front side pulley device as viewed from an upper side.

FIG. 7 is a view of the front side pulley device as viewed from a rear side.

FIG. 8 is a perspective view showing details of an inner side of a base member.

FIG. 9 is a perspective view showing details of an inner side of the cover member.

FIG. 10 is a perspective view for describing a routing state of a cable inside a pulley case.

### DESCRIPTION OF THE EMBODIMENTS

According to the disclosure, a pulley device capable of extending a maintenance cycle can be realized.

Hereinafter, an embodiment of the disclosure will be described in detail using the drawings.

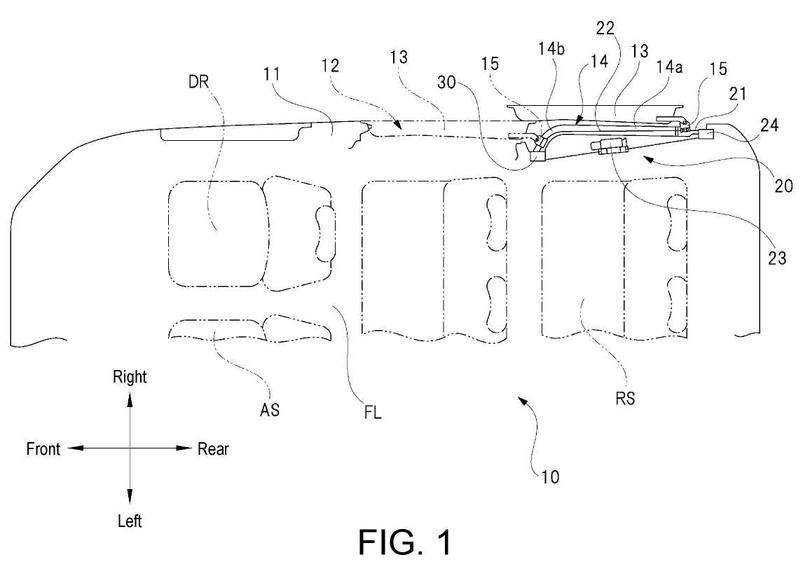

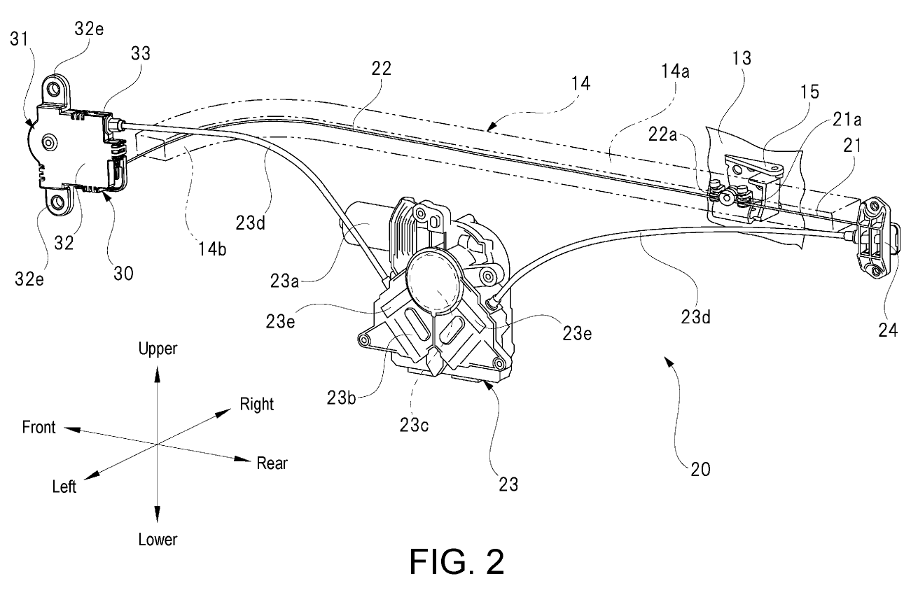

FIG. 1 is a schematic view of a vehicle equipped with a power slide door device. FIG. 2 is a perspective view showing the power slide door device of FIG. 1.

### <Overview of slide door>

A vehicle 10 shown in FIG. 1 is a one-box vehicle. A relatively large opening part 12 is provided on a side part of a vehicle body 11 forming the vehicle 10, through which passengers embark and disembark and luggage is loaded and unloaded. The opening part 12 is opened and closed by a slide door 13 that moves in a front-rear direction of the vehicle body 11. Here, the slide door 13 is movable along a guide rail 14 fixed to the side part of the vehicle body 11.

As shown in FIG. 1 and FIG. 2, the guide rail 14 is fixed at a substantially central part along an upper-lower direction of the vehicle body 11 and on a rear side of the opening part 12. The guide rail 14 includes a linear part 14a extending in a front-rear direction of the vehicle body 11, and a curved part 14b curved from the front side of the linear part 14a toward a vehicle interior side (left side).

In addition, a roller assembly 15 is provided on the rear side of the slide door 13. The roller assembly 15 is movably mounted on the guide rail 14. The slide door 13 opens and closes the opening part 12 through the roller assembly 15 moving in the front-rear direction of the vehicle body 11 along the guide rail 14.

Specifically, when the roller assembly 15 is moved to the rear side of the linear part 14a of the guide rail 14, the slide door 13 is in an open state (see the solid line in FIG. 1). In addition, when the roller assembly 15 is moved to the front side of the curved part 14b of the guide rail 14, the slide door 13 is pulled toward the vehicle interior side and is in a closed state (see the two-dot chain line in FIG. 1).

Furthermore, a power slide door device 20 is mounted on the vehicle body 11 to automatically open and close the slide door 13.

Here, the side of the vehicle body 11 where a driver seat DR is arranged is defined as "right side," and the side where a passenger seat AS is arranged is defined as "left side. " In addition, the side of the vehicle body 11 where the driver seat DR and the passenger seat AS are arranged is defined as "front side," and the side where a rear seat RS is arranged is defined as "rear side." Furthermore, the side of the vehicle body 11 where a floor surface FL is arranged is defined as "lower side," and a side where a ceiling (not shown) is arranged is defined as "upper side."

### <Power slide door device>

The power slide door device 20 includes: an open side cable 21 connected to the rear side of the roller assembly 15; and a closed side cable 22 connected to the front side of the roller assembly 15. That is, the power slide door device 20 is a cable type automatic opening and closing device. In addition, the power slide door device 20 has a drive source 23 that drives the open side cable 21 and the closed side cable 22. The drive source 23 is arranged at a substantially central part of the guide rail 14 along a longitudinal direction and on the vehicle interior side. Therefore, the drive source 23 is not exposed to wind and rain.

The moving direction of the open side cable 21 pulled out from the drive source 23 toward the rear side is converted to the front side by a rear side pulley device 24 provided on the rear side of the guide rail 14. The tip of the open side cable 21 is connected to the roller assembly 15 from the rear side of the guide rail 14. In addition, the moving direction of the closed side cable 22 pulled out from the drive source 23 toward the front side is converted to the rear side by a front side pulley device 30 provided on the front side of the guide rail 14. The tip of the closed side cable 22 is connected to the roller assembly 15 from the front side of the guide rail 14.

As shown in FIG. 2, the drive source 23 includes a motor part 23a and a drive part 23b that drives the open side cable 21 and the closed side cable 22 through driving of the motor part 23a. The motor part 23a can rotate the rotation shaft (not shown) thereof in forward and reverse directions by switching an energization state.

In addition, the drive part 23b includes a drum 23c provided with grooves around which the open side cable 21 and the closed side cable 22 are respectively wound. Specifically, base end parts of the open side cable 21 and the closed side cable 22 are fixed to the drum 23c, and the open side cable 21 and the closed side cable 22 are wound around the grooves of the drum 23c in mutually opposite directions.

Accordingly, when the drum 23c is rotated forward, the open side cable 21 is wound around the drum 23c, and the closed side cable 22 is sent out from the drum 23c. Therefore, the slide door 13 is pulled rearward and operated to open. Comparatively, when the drum 23c is rotated in reverse, the closed side cable 22 is wound around the drum 23c, and the open side cable 21 is sent out from the drum 23c. Therefore, the slide door 13 is pulled forward and operated to close.

Here, between the drive part 23b and the rear side pulley device 24 as well as the front side pulley device 30, outer casings 23d that guide the movement of the open side cable 21 and the closed side cable 22 are respectively provided. Inside the outer casings 23d, a lubricant (not shown) such as grease is applied. Therefore, the open side cable 21 and the closed side cable 22 can each move smoothly.

The drive part 23b is provided with tensioner mechanisms 23e respectively corresponding to the open side cable 21 and the closed side cable 22. The tensioner mechanisms 23e serve to apply a constant tension to the open side cable 21 and the closed side cable 22. Accordingly, even if the open side cable 21 and the closed side cable 22 stretch due to changes through time or the like, the slack can be removed.

### <Front side pulley device>

Next, the detailed structure of the front side pulley device 30 to which the disclosure is applied will be described with reference to the drawings. However, the disclosure can be applied not only to the front side pulley device 30 but also to the rear side pulley device 24. The front side pulley device 30 corresponds to the pulley device in the disclosure.

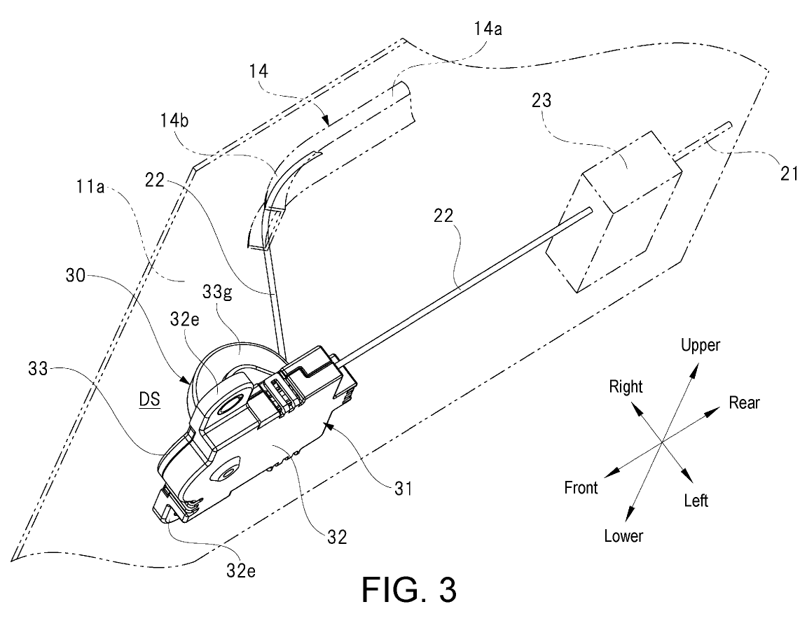

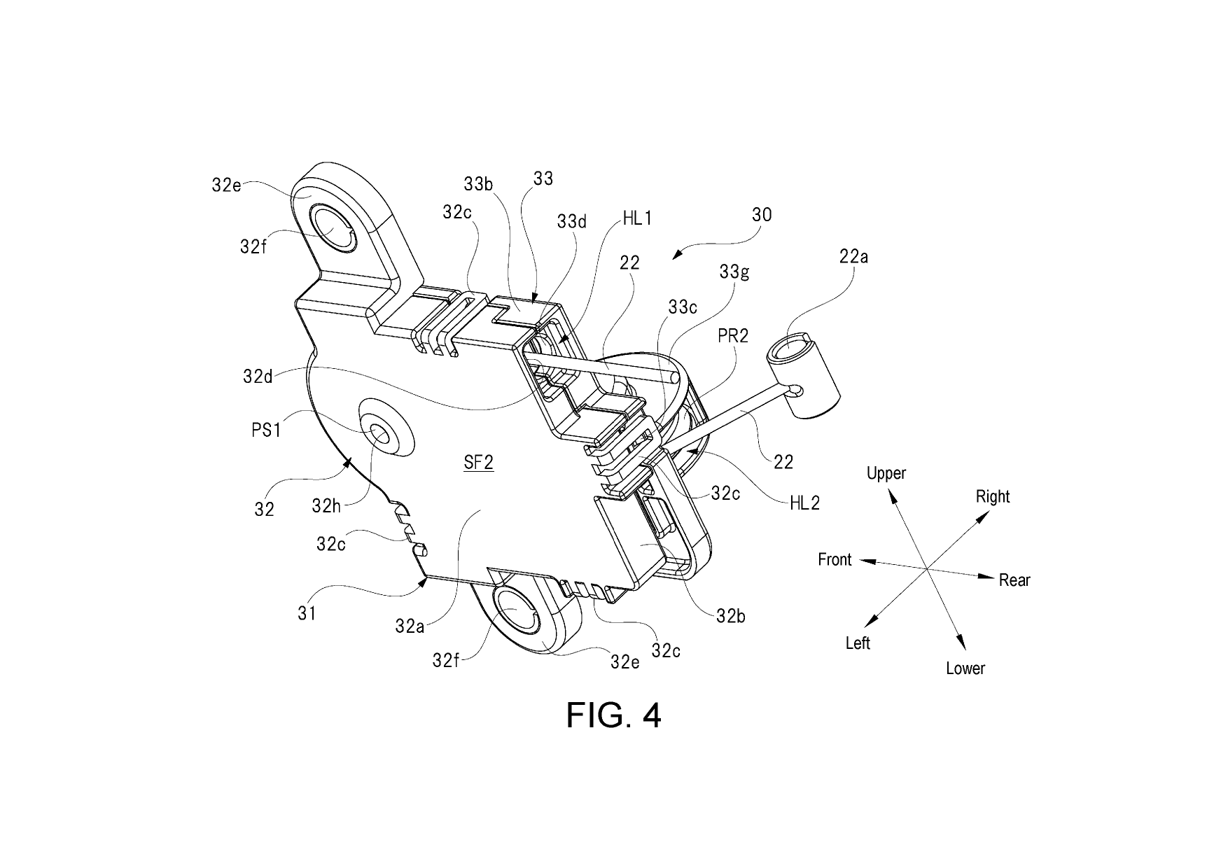

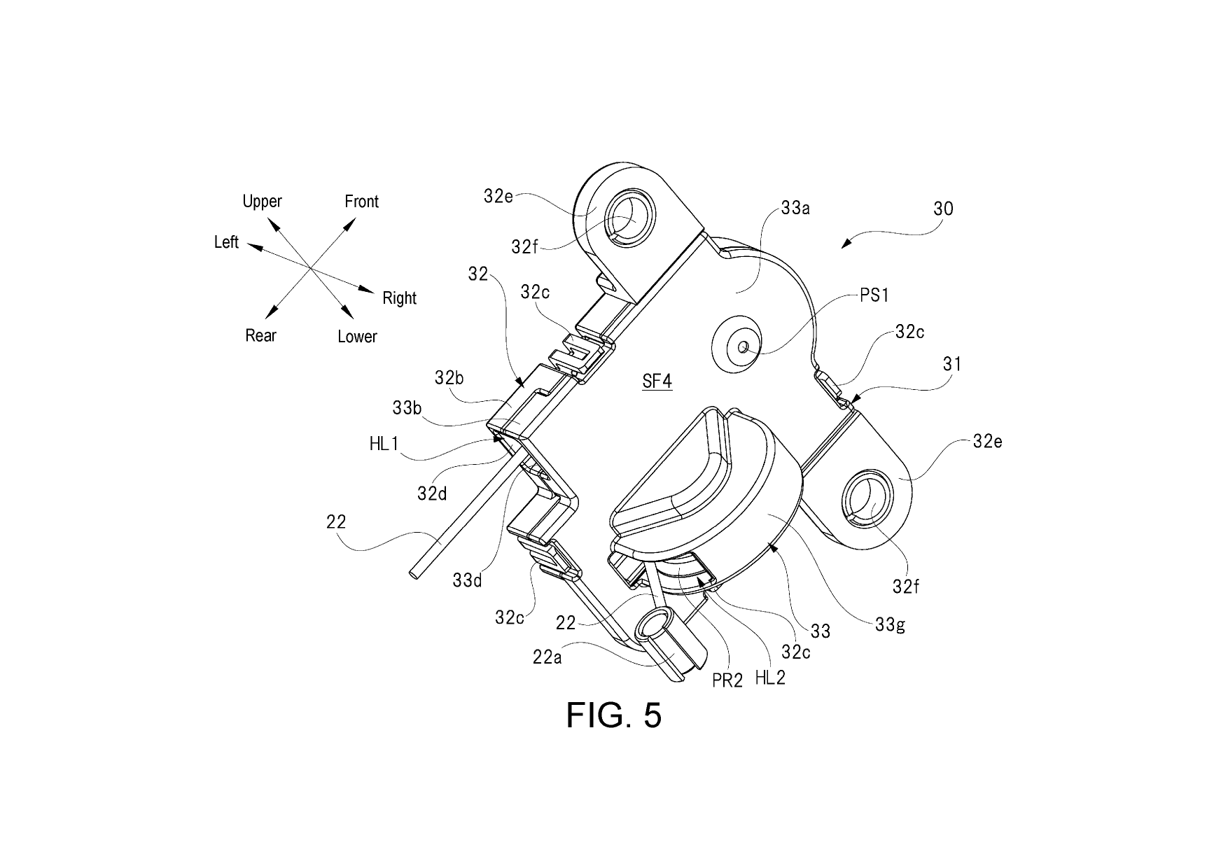

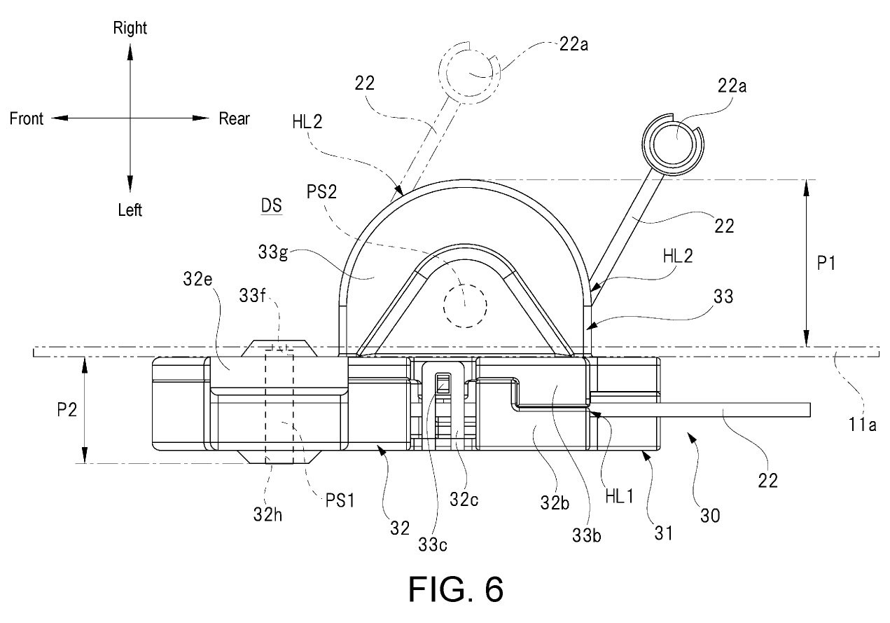

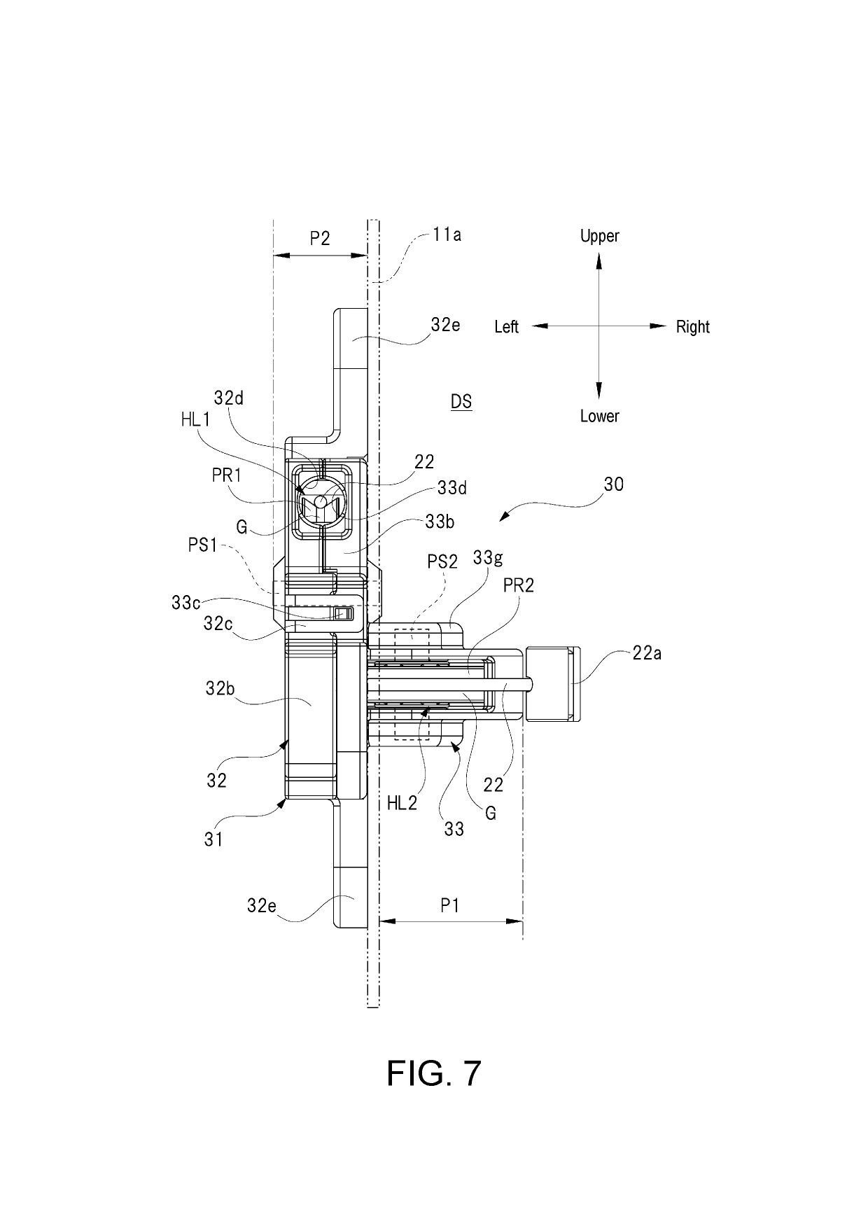

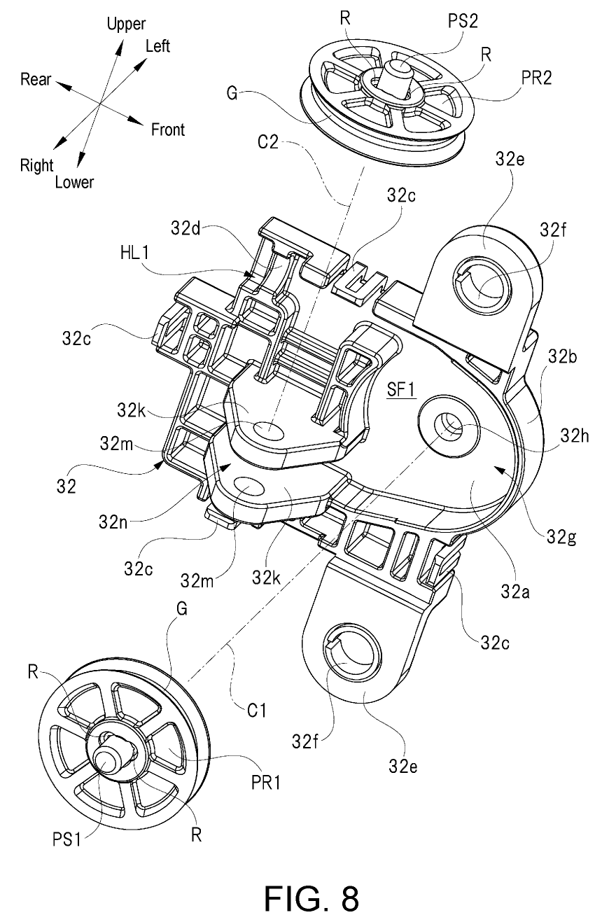

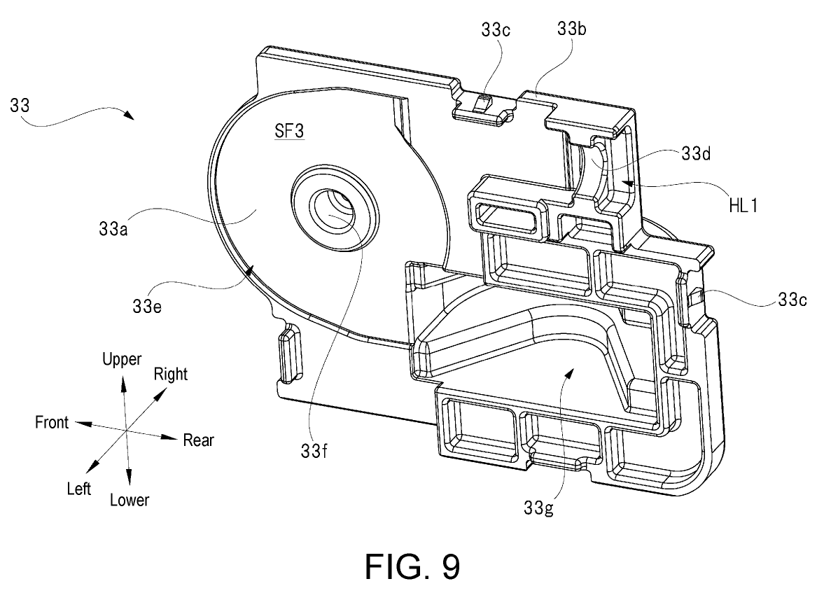

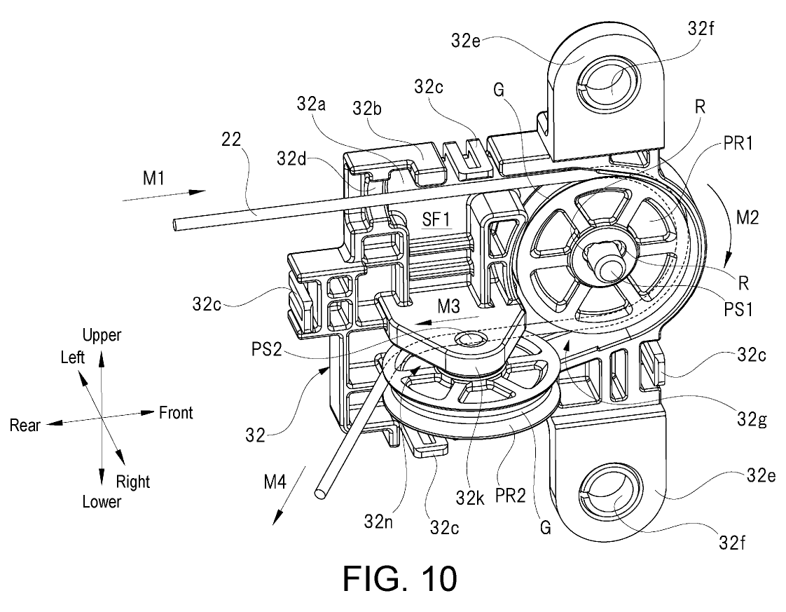

FIG. 3 is a perspective view describing the mounting structure of the front side pulley device to the body panel. FIG. 4 is a perspective view of the front side pulley device as viewed from the left side and the rear side. FIG. 5 is a perspective view of the front side pulley device as viewed from the right side and the rear side. FIG. 6 is a view of the front side pulley device as viewed from above. FIG. 7 is a view of the front side pulley device as viewed from the rear side. FIG. 8 is a perspective view showing details of the inside of the base member. FIG. 9 is a perspective view showing details of the inside of the cover member. FIG. 10 is a perspective view describing the routing state of the cable inside the pulley case.

As shown in FIG. 3 to FIG. 5, the front side pulley device 30 includes a pulley case 31 that forms the outer shell thereof. The pulley case 31 is a portion fixed to the body panel 11a forming the vehicle body 11 (see FIG. 1), and specifically, is fixed to the vehicle interior side of the body panel 11a. The pulley case 31 adopts a split structure and includes a base member 32 and a cover member 33. Both the base member 32 and the cover member 33 are injection molded articles made of a resin material, such as a plastic material. The body panel 11a corresponds to the mounting object in the disclosure.

In the state where the front side pulley device 30 is fixed to the body panel 11a, the base member 32 is arranged on the vehicle interior side, and the cover member 33 is arranged on the vehicle exterior side (right side). Specifically, the body panel 11a is provided with a through hole (not shown) penetrating through the vehicle interior side and the vehicle exterior side, and the pulley case 31 is provided to straddle the body panel 11a via the through hole (see FIG. 6 and FIG. 7).

The pulley case 31 has a portion on the side of the cover member 33 that protrudes, but other portions have a substantially thin-walled, substantially box-like shape. Therefore, an increase in size of the front side pulley device 30 can be suppressed. Additionally, the protruding portion of the cover member 33 is arranged in a dead space DS (see FIG. 3, FIG. 6, and FIG. 7) on the vehicle exterior side of the body panel 11a.

In FIG. 3, the illustration of the drive source 23 is simplified. Additionally, in FIG. 3 to FIG. 7 and FIG. 10, the illustration of the outer casing 23d is omitted.

### <Base member>

As shown in FIG. 4 and FIG. 8, the base member 32 includes a base side bottom wall part 32a that extends in the upper-lower direction and the front-rear direction and is formed in a plate shape. A base side inner surface SF1 is provided on the inner side (right side) of the base side bottom wall part 32a, and a base side outer surface SF2 is provided on the outer side (left side) of the base side bottom wall part 32a. Additionally, a base side sidewall part 32b that protrudes from the base side bottom wall part 32a toward the vehicle exterior side (right side) at a predetermined height is integrally provided at an outer edge portion of the base side bottom wall part 32a.

The base side sidewall part 32b is integrally provided with a total of four engagement claw parts 32c that are respectively hooked to engagement convex parts 33c (see FIG. 9) of the cover member 33. Accordingly, the base member 32 and the cover member 33 are butted against each other in the vehicle width direction (left-right direction) of the vehicle body 11 and are connected so as not to rattle against each other.

Additionally, on the side of the base side inner surface SF1 of the base side bottom wall part 32a, a base side fixing recess 32d to which an end part of the outer casing 23d (see FIG. 2) is fixed is provided. Furthermore, the base side sidewall part 32b is integrally provided with a pair of fixing parts 32e fixed to the body panel 11a.

The pair of fixing parts 32e provided on the base member 32 are arranged opposite to each other in the upper-lower direction of the base member 32. Specifically, one (upper) fixing part 32e protrudes upward from the base side sidewall part 32b of the base member 32 at a predetermined height. Additionally, the other (lower) fixing part 32e protrudes downward from the base side sidewall part 32b of the base member 32 at a predetermined height. Furthermore, the pair of fixing parts 32e are arranged on the right side (the front side in FIG. 8, on the vehicle exterior side) of the base side sidewall part 32b in the left-right direction of the base member 32.

Additionally, the pair of fixing parts 32e are each provided with a bolt insertion hole 32f that penetrates in the left-right direction. Fixing bolts (not shown) for fixing the front side pulley device 30 to the body panel 11a are respectively inserted through the bolt insertion holes 32f.

### <First pulley accommodating part>

Furthermore, as shown in FIG. 8, a first pulley accommodating part 32g is provided on the interior side of the base member 32 and between the pair of fixing parts 32e along the upper-lower direction. The first pulley accommodating part 32g is a portion that rotatably accommodates a first pulley PR1 around which the closed side cable 22 is wound, and a base side shaft fixing hole 32h is provided at a substantially central part of the first pulley accommodating part 32g. One end part (left end part) of the first pulley shaft PS1 is fixed to the base side shaft fixing hole 32h. The other end part (right end part) of the first pulley shaft PS1 is fixed to a cover side shaft fixing hole 33f (see FIG. 9) provided in the cover member 33. In this manner, the first pulley shaft PS1 is provided in the first pulley accommodating part 32g.

Here, both the base side shaft fixing hole 32h and the cover side shaft fixing hole 33f extend in the left-right direction of the front side pulley device 30. That is, the axis C1 of the first pulley shaft PS1 fixed to the base side shaft fixing hole 32h and the cover side shaft fixing hole 33f extends in the vehicle width direction (left-right direction) of the vehicle body 11.

The first pulley accommodating part 32g is provided inside the pulley case 31 and corresponds to the pulley accommodating part in the disclosure. Additionally, the first pulley shaft PS1 corresponds to the pulley shaft in the disclosure. Furthermore, the first pulley PR1 corresponds to the pulley in the disclosure.

### <Second pulley accommodating part>

Additionally, as shown in FIG. 8, a pair of shaft support protrusions 32k that support both end parts of the second pulley shaft PS2 are provided on the rear side of the first pulley accommodating part 32g. The shaft support protrusions 32k are arranged at predetermined intervals in the upper-lower direction of the front side pulley device 30 and protrude from the base side inner surface SF1 toward the vehicle exterior side (right side) at a predetermined height. Specifically, the protrusion height of the pair of shaft support protrusions 32k is higher than the base side sidewall part 32b. Therefore, the tip side of the pair of shaft support protrusions 32k is arranged on the vehicle exterior side relative to the pair of fixing parts 32e.

Shaft fixing holes 32m, to which both sides of the second pulley shaft PS2 in the axial direction are respectively fixed, are provided in portions near the tips of the pair of shaft support protrusions 32k. Accordingly, the second pulley PR2, around which the closed side cable 22 is wound and which is rotatably supported by the second pulley shaft PS2, is rotatably accommodated between the pair of shaft support protrusions 32k. That is, the second pulley accommodating part 32n is provided between the pair of shaft support protrusions 32k, and the second pulley shaft PS2 is provided in the second pulley accommodating part 32n.

The second pulley accommodating part 32n is provided inside the pulley case 31 and corresponds to the pulley accommodating part in the disclosure. Additionally, the second pulley shaft PS2 corresponds to the pulley shaft in the disclosure. Furthermore, the second pulley PR2 corresponds to the pulley in the disclosure.

Here, each of the shaft fixing holes 32m extends in the upper-lower direction of the front side pulley device 30. That is, the axis C2 of the second pulley shaft PS2 fixed to the pair of shaft fixing holes 32m extends in the upper-lower direction of the front side pulley device 30.

Therefore, when the first pulley shaft PS1 and the second pulley shaft PS2 are viewed from the front-rear direction of the front side pulley device 30, the angle formed between them is 90 degrees (right angle) (see FIG. 7). In this manner, the first pulley shaft PS1 arranged on the axis C1 and the second pulley shaft PS2 arranged on the axis C2 extend in directions different from each other. Specifically, the first pulley shaft PS1 and the second pulley shaft PS2 are in "skew positions" that are neither parallel to nor intersecting each other.

By arranging the first pulley shaft PS1 and the second pulley shaft PS2 in this manner, as shown in FIG. 5, FIG. 6, and FIG. 10, the first pulley PR1 and the second pulley PR2 are arranged close to each other, while allowing the closed side cable 22 to be wound around the first pulley PR1 and the second pulley PR2 without being excessively curved. Furthermore, in the left-right direction (vehicle width direction) of the front side pulley device 30, a first cable entry and exit hole HL1 and a second cable entry and exit hole HL2 can be arranged close to each other, and the second cable entry and exit hole HL2 on the side where the slide door 13 is arranged can be brought closer to the body panel 11a. Therefore, the installation space for the front side pulley device 30 can be reduced (space saving).

Here, assuming the case where the first pulley PR1 is eliminated and only the second pulley PR2 is used, the second cable entry and exit hole HL2 is arranged at a portion near the tip of the pair of shaft support protrusions 32k (see FIG. 8). Therefore, the closed side cable 22 is routed as shown by the two-dot chain line in FIG. 6, and with such routing of the closed side cable 22, the installation space for the front side pulley device 30 becomes large. The closed side cable 22 corresponds to the cable in the disclosure.

Additionally, the pulley case 31 is formed from the base member 32 fixed to the body panel 11a and the cover member 33 covering the base member 32, and the base member 32 is provided with the first pulley accommodating part 32g and the second pulley accommodating part 32n.

Accordingly, compared to the case where the first pulley accommodating part 32g and the second pulley accommodating part 32n are provided in separate members, for example, it is possible to improve the arrangement accuracy of the first pulley accommodating part 32g and the second pulley accommodating part 32n. In other words, the arrangement accuracy between the first pulley shaft PS1 (first pulley PR1) and the second pulley shaft PS2 (second pulley PR2) can be improved. Therefore, the abnormal noise during operation of the front side pulley device 30 can be suppressed from generating, and consequently quietness can be improved.

### <Cover member>

As shown in FIG. 5 and FIG. 9, the cover member 33 covers the side of the base side inner surface SF1 of the base member 32, and includes a cover side plate part 33a that extends in the upper-lower direction and the front-rear direction and is formed in a plate shape. A cover side inner surface SF3 is provided on the inner side (left side) of the cover side plate part 33a, and a cover side outer surface SF4 is provided on the outer side (right side) of the cover side plate part 33a.

Here, the cover side plate part 33a is thicker than the base side bottom wall part 32a (see FIG. 8) of the base member 32, and a total of four engaging convex parts 33c are integrally provided on the outer edge part 33b of the cover side plate part 33a. A total of four engaging claw parts 32c provided on the base side sidewall part 32b are configured to be hooked onto the engaging convex parts 33c, respectively.

Additionally, on the side of the cover side inner surface SF3 side of the cover side plate part 33a, a cover side fixing recess 33d is provided which faces the base side fixing recess 32d (see FIG. 8) and to which the end part of the outer casing 23d (see FIG. 2) is fixed.

Here, the base side fixing recess 32d and the cover side fixing recess 33d, to which the end parts of the outer casing 23d are fixed, are arranged on the side of the drive source 23 of the front side pulley device 30, and form a first cable entry and exit hole HL1 through which the closed side cable 22 enters and exits the pulley case 31.

### <First pulley cover part>

Furthermore, as shown in FIG. 9, a first pulley cover part 33e is provided on the inner side and the front side of the cover member 33. The first pulley cover part 33e is a portion that covers the first pulley accommodating part 32g (see FIG. 8) from the right side of the front side pulley device 30. A cover side shaft fixing hole 33f, to which the other end part (right end part) of the first pulley shaft PS1 is fixed, is provided at a substantially central part of the first pulley cover part 33e. In this manner, both sides of the first pulley shaft PS1 in the axial direction are fixed to the base member 32 and the cover member 33 of the pulley case 31, respectively.

### <Second pulley cover part>

Additionally, as shown in FIG. 9, a second pulley cover part 33g is provided on the rear side of the first pulley cover part 33e. The second pulley cover part 33g is a portion that covers the second pulley accommodating part 32n (see FIG. 8) from the right side of the front side pulley device 30. Specifically, the second pulley cover part 33g protrudes from the cover side outer surface SF4 of the cover side plate part 33a to the right side of the front side pulley device 30 at a predetermined height, so as to be able to cover the pair of shaft support protrusions 32k (see FIG. 8) provided on the base member 32. As a result, the pair of shaft support protrusions 32k, the second pulley shaft PS2, and the second pulley PR2 are covered by the second pulley cover part 33g.

Furthermore, as shown in FIG. 5, the second pulley cover part 33g is provided with a second cable entry and exit hole HL2. The second cable entry and exit hole HL2 is arranged on the side of the roller assembly 15 (see FIG. 2) of the front side pulley device 30, and serves as an opening through which the closed side cable 22 enters and exits the pulley case 31.

In this manner, the front side pulley device 30 is provided with a first cable entry and exit hole HL1 and a second cable entry and exit hole HL2 that communicate the inside and outside of the pulley case 31. The first cable entry and exit hole HL1 and the second cable entry and exit hole HL2 respectively communicate the inside and outside of the pulley case 31, and correspond to the cable entry and exit hole in the disclosure.

Here, as shown in FIG. 6 and FIG. 7, in a state where the front side pulley device 30 is fixed to the body panel 11a, with the body panel 11a to which the pulley case 31 (the pair of fixing parts 32e) is fixed as the center, the first pulley shaft PS1 is arranged on one side of the body panel 11a (on the left side in the vehicle width direction and on the vehicle interior side), and the second pulley shaft PS2 is arranged on the other side of the body panel 11a (on the right side in the vehicle width direction and on the vehicle exterior side).

As a result, the side of the second pulley PR2 (protrusion amount P1) of the front side pulley device 30 can be arranged in the dead space DS on the vehicle exterior side (right side) of the body panel 11a. On the other hand, the side of the first pulley PR1 (protrusion amount P2) of the front side pulley device 30 is arranged on the vehicle interior side (left side) of the body panel 11a, but since the protrusion amount P2 is substantially a half of the protrusion amount P1 (P2≒P1/2), narrowing of the vehicle interior side can be suppressed.

### <Pulley structure>

As shown in FIG. 8, the first pulley PR1 and the second pulley PR2 both adopt the same configuration. The first pulley PR1 is rotatably supported by the first pulley shaft PS1, and the second pulley PR2 is rotatably supported by the second pulley shaft PS2. The first pulley PR1 and the second pulley PR2 are each formed in a substantially disk shape, and cable grooves G are respectively provided on the outer peripheral portions thereof. The closed side cable 22 enters the cable grooves G of the first pulley PR1 and the second pulley PR2 in a curved state.

In addition, multiple grease accommodating recesses R are provided on the inner peripheral portions of the first pulley PR1 and the second pulley PR2, so as to face the outer peripheral portions of the first pulley shaft PS1 and the second pulley shaft PS2. The grease accommodating recesses R accommodate a predetermined amount of lubricant (not shown), such as grease. That is, the grease accommodating recesses R serve as the so-called "grease reservoirs". As a result, the first pulley PR1 and the second pulley PR2 can rotate smoothly with respect to the first pulley shaft PS1 and the second pulley shaft PS2 over a long period of time.

### <Cable structure>

Furthermore, as shown in FIG. 4 and FIG. 5, the closed side cable 22 wound around the first pulley PR1 and the second pulley PR2 is formed by twisting multiple metal fine wires (not shown), and the surface thereof is covered with a protective coating (not shown) made of resin. This prevents the metal fine wires from rusting. A closed side cable end part 22a having a cylindrical shape (e.g., a drum shape) is integrally provided on the side of the slide door 13 (the side of the roller assembly 15) in the longitudinal direction of the closed side cable 22. The closed side cable end part 22a is attached to the front side of the roller assembly 15 (see FIG. 2).

As shown in FIG. 2, in the open side cable 21 as well, similar to the closed side cable 22, an open side cable end part 21a is integrally provided on the side of the slide door 13 (the roller assembly 15 side). The open side cable end part 21a is attached to the rear side of the roller assembly 15 (see FIG. 2).

### <Assembling procedure>

Next, the assembling procedure of the front side pulley device 30 formed as described above will be described in detail by using the drawings. The assembling procedure shown below is an example, and the device can be assembled by adopting other procedures.

First, as shown in FIG. 8, one end of the first pulley shaft PS1 is inserted into and fixed to the base side shaft fixing hole 32h. Next, as shown by arrows M1 and M2 in FIG. 10, the closed side cable 22 is wound around the cable groove G of the first pulley PR1, and the first pulley PR1 is mounted on the first pulley shaft PS1. At this time, a predetermined amount of grease is coated on the grease accommodating recess R. In addition, as shown by arrow M3 in FIG. 10, the closed side cable 22 is arranged between the pair of shaft support protrusions 32k.

After that, the second pulley PR2 is inserted between the pair of shaft support protrusions 32k, and the closed side cable 22 is wound around the cable groove G of the second pulley PR2. In addition, the axis of the second pulley PR2 and the axes of the pair of shaft fixing holes 32m are respectively arranged coaxially. Then, the second pulley shaft PS2 is mounted in the pair of shaft fixing holes 32m including the inner peripheral part of the second pulley PR2.

Next, the cover member 33 (see FIG. 5 and FIG. 9) is prepared. Then, as shown by arrow M4 in FIG. 10, while pulling the closed side cable 22 (closed side cable end part 22a), the closed side cable 22 is inserted through the second cable entry and exit hole HL2 of the cover member 33 from the side of the cover side inner surface SF3 toward the cover side outer surface SF4.

After that, the base side inner surface SF1 of the base member 32 and the cover side inner surface SF3 of the cover member 33 face toward each other, and the cover side shaft fixing hole 33f (see FIG. 9) of the cover member 33 is arranged on the axis of the first pulley shaft PS1. Then, the other end of the first pulley shaft PS1 is inserted into and fixed to the cover side shaft fixing hole 33f. Furthermore, a total of four engaging claw parts 32c are hooked onto a total of four engaging protrusions 33c.

As a result, the assembling work of the front side pulley device 30 is completed.

As described in detail above, according to the embodiment, the front side pulley device 30 that converts the moving direction of the closed side cable 22 driven by the drive source 23 includes: the pulley case 31 fixed to the body panel 11a; the first pulley accommodating part 32g and the second pulley accommodating part 32n provided inside the pulley case 31; the first pulley shaft PS1 and the second pulley shaft PS2 respectively provided in the first pulley accommodating part 32g and the second pulley accommodating part 32n; the first pulley PR1 and the second pulley PR2 which are rotatably supported by the first pulley shaft PS1 and the second pulley shaft PS2 respectively and around which the closed side cable 22 is wound; and the first and second cable entry and exit holes HL1 and HL2 provided in the pulley case 31 and communicating the inside and outside of the pulley case 31.

As a result, the moving direction of the closed side cable 22 can be converted by the first pulley PR1 and the second pulley PR2 that are rotated together with the movement of the closed side cable 22. Therefore, the portions where the closed side cable 22 rubs can be eliminated, and wear of the surface of the closed side cable 22 can be prevented. Accordingly, the front side pulley device 30 can be operated smoothly over a long period, and the maintenance cycle of the front side pulley device 30 (power slide door device 20) can be extended.

Further, according to the embodiment, the first pulley shaft PS1 and the second pulley shaft PS2 are in skew positions relative to each other.

As a result, the first pulley PR1 and the second pulley PR2 can be arranged close to each other, and the closed side cable 22 can be wound around the first pulley PR1 and the second pulley PR2 without being forcibly curved (see FIG. 10). Further, in the left-right direction of the front side pulley device 30, the first cable entry and exit hole HL1 and the second cable entry and exit hole HL2 can be arranged close to each other (see FIG. 6). Therefore, while ensuring the smooth operation of the front side pulley device 30, the installation space can be reduced to achieve space saving.

Furthermore, according to the embodiment, the pulley case 31 is provided to straddle the body panel 11a, the first pulley shaft PS1 is arranged on one side (left side) of the body panel 11a, and the second pulley shaft PS2 is arranged on the other side (right side) of the body panel 11a.

As a result, the side of the second pulley PR2 (projection amount P1) of the front side pulley device 30 can be arranged in the dead space DS on the vehicle exterior side (right side) of the body panel 11a. Therefore, the projection amount P2 of the front side pulley device 30 toward the vehicle interior side can be reduced, and narrowing of the vehicle interior side can be suppressed.

Further, according to the embodiment, the pulley case 31 includes: the base member 32 fixed to the body panel 11a; and the cover member 33 covering the base member 32, and the base member 32 is provided with the first pulley accommodating part 32g and the second pulley accommodating part 32n.

As a result, the arrangement accuracy of the first pulley accommodating part 32g and the second pulley accommodating part 32n can be improved, and consequently the arrangement accuracy of the first pulley PR1 including the first pulley shaft PS1 and the second pulley PR2 including the second pulley shaft PS2 can be improved. Therefore, the generation of abnormal noise during the operation of the front side pulley device 30 can be suppressed, and consequently quietness can be improved.

Furthermore, according to the embodiment, the maintenance cycle of the front side pulley device 30 can be extended, so the energy required for disassembly work and reassembly work can be saved. Therefore, it is possible to achieve, in particular, Goal 7 (ensure access to affordable, reliable, sustainable and modern energy for all) and Goal 13 (take urgent action to combat climate change and its impacts) in the Sustainable Development Goals (SDGs) established by the United Nations.

The disclosure is not limited to the embodiment, and it goes without saying that various modifications can be made without departing from the gist thereof. For example, in the embodiment, the pulley case 31 having the first pulley accommodating part 32g and the second pulley accommodating part 32n inside, that is, including the first pulley PR1 and the second pulley PR2, has been shown, but the disclosure is not limited thereto and can be applied to a pulley case having three or more pulleys inside.

Further, in the embodiment, the front side pulley device 30 of the power slide door device 20 in which the drive source 23 is fixed to the vehicle body 11 has been shown, but the disclosure is not limited thereto and can be applied to a pulley device of a power slide door device in which the drive source is fixed inside the slide door 13.

In addition, the material, shape, dimensions, number, installation location, and the like of each component in the embodiment may be arbitrary as long as the disclosure can be achieved, and are not limited to the above embodiment.

What is claimed is:

1. A pulley device, converting a moving direction of a cable driven by a drive source, the pulley device comprising:
a pulley case, fixed to a mounting object;
a plurality of pulley accommodating parts, provided inside the pulley case;
a pulley shaft, provided in each of the pulley accommodating parts;
a plurality of pulleys, which are respectively rotatably supported by the pulley shafts and around which the cable is wound; and
a pair of cable entry and exit holes, provided in the pulley case and communicating between inside and outside of the pulley case.

2. The pulley device as claimed in claim 1, wherein the pulley case comprises:
a first pulley accommodating part, in which a first pulley shaft is provided; and
a second pulley accommodating part, in which a second pulley shaft is provided,
wherein the first pulley shaft and the second pulley shaft are in skew positions relative to each other.

3. The pulley device as claimed in claim 2,
wherein the pulley case is provided to straddle the mounting object,
the first pulley shaft is arranged on a side of the mounting object, and
the second pulley shaft is arranged on an other side of the mounting object.

4. The pulley device as claimed in claim 2,
wherein the pulley case comprises:
a base member, fixed to the mounting object; and
a cover member, covering the base member, and
the base member is provided with the first pulley accommodating part and the second pulley accommodating part.

5. The pulley device as claimed in claim 3,
wherein the pulley case comprises:
a base member, fixed to the mounting object; and
a cover member, covering the base member, and
the base member is provided with the first pulley accommodating part and the second pulley accommodating part.
